(19) United States
(12) Patent Application Publication
(10) Pub. No.: US 2010/0161592 A1
(43) Pub. Date: Jun. 24, 2010

(54) Query Intent Determination Using Social Tagging

(76) Inventor: Colin Shengcai Zhao, Sunnyvale, CA (US)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 12/341,909

(22) Filed: Dec. 22, 2008

(51) Int. Cl. G06F 7/06; G06F 17/30

(52) U.S. Cl. 707/722; 707/E17.108

(57) ABSTRACT

A method and system for using social tagging to identify a search engine user's intent are described. A search engine selects a set of pages that are relevant to a query. The engine determines neighbors of these pages and groups the neighbors into topical clusters. For each cluster, the engine determines tags that a community of users has frequently associated with pages in that cluster. For each cluster, the engine matches that cluster's dominant tags with phrases in various intent lists. By matching a particular cluster's tags to various lists, an intent corresponding to that particular cluster is determined. For each cluster's intent, the search engine may present, with query results, types of content that correspond especially to that intent (e.g., a map for a location intent, possibly along with driving directions). Additionally or alternatively, for each such intent, the search engine may format the query results in a manner that suits the intent.

### FIELD OF THE INVENTION

The present disclosure relates generally to internet-based search engines, and more specifically to systems and methods for ascertaining a searcher's specific intent using social tagging.

### BACKGROUND OF THE INVENTION

The approaches described in this section are approaches that could be pursued, but are not necessarily approaches that have been previously conceived or pursued. Therefore, unless otherwise indicated, it should not be assumed that any of the approaches described in this section qualify as prior art merely by virtue of their inclusion in this section.

The World Wide Web is a decentralized global collection of interlinked information, generally in the form of “pages” that can be accessed over the Internet. Each page, or web page, typically contains text, images, and/or media content. In instances where a user knows a web page's uniform resource locator (URL), the user can enter the URL directly into a web client and view the web page instantly. Frequently, however, a user does not know a web pages' URL or does not have a specific web page in mind, but instead only has an idea of desired subject matter.

In instances when the user does not know the URL of a desired web page, the user can enter a query into a search engine such as YAHOO!®. A search engine typically maintains databases of web pages in which the URL of each page is associated with information (e.g., keywords, category data, etc.) reflecting the page's content. The search engine also maintains a search server that hosts a search page (or site) on the Web. The search page is delivered to a user's web client and can provide the user with a form into which a query including one or more terms indicative of the user's interest can be entered. Once a query is entered, the search server accesses the databases and generates a list of “hits” or “results,” typically in the form of URLs for pages whose content matches keywords derived from the user's query. This list is presented to the user on the user's web client (e.g., an Internet browser such as Microsoft Internet Explorer or Mozilla Firefox).

With queries often returning millions of hits, search engine providers have developed sophisticated algorithms for ranking the results (i.e., determining an order for displaying hits to the user) such that the results most relevant to a given query are likely to appear near the top of the list. Typical ranking algorithms take into account not only the keywords and their frequency of occurrence but also other information such as the number of other pages that link to the hit page, popularity of the hit page among users, and so on.

While automated search technologies can be very helpful, they do have a number of technological limitations, a primary one being that a user often has difficulty formulating a query to direct the search to relevant content. A query that is too general might return a large quantity of hits, few of which are relevant. A query that is too specific might fail to return many relevant hits. A user often has a fairly specific intent in mind at the time of making a query, and may want a specific type of web page returned. Techniques for ascertaining a search engine user's intent are needed.

### BRIEF DESCRIPTION OF THE DRAWINGS

The present invention is illustrated by way of example, and not by way of limitation, in the figures of the accompanying drawings.

FIG. 1 shows a search engine system embodying aspects of the present invention.

FIG. 2 shows a generic representation of a search engine user interface that might be implemented into embodiments of the present invention.

FIGS. 3a and 3b show flow charts illustrating methods for using tags to determine content or formatting for returned search results.

FIG. 4 shows a graphical representation of a webmap.

FIG. 5 shows a block diagram of a network architecture that could be used to implement a search engine embodying aspects of the present invention.

FIG. 6 shows a block diagram of a user terminal that could be used to implement aspects of the present invention.

### DETAILED DESCRIPTION OF EMBODIMENTS OF THE INVENTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview

Techniques described herein automatically determine formatting or content to return to a search engine user based on user community-supplied tags. The tags can, for example, be used to determine the user's intent. Some of these techniques provide, with query results, a type of content that is relevant to the determined intent(s). Some of these techniques format such query results in a way that suits the determined intent(s). According to one embodiment of the invention, a search engine selects, from a corpus of web pages, a set of web pages that are relevant to the user's query. The search engine determines neighbors of these relevant web pages based on relationships between these relevant pages and other pages (e.g., based on in-links and out-links), and groups the neighbors into topical clusters. For each topical cluster, the search engine determines one or more tags that a community of users has frequently associated with pages in that cluster. Thus, each cluster is associated with a distinct tag set. For each cluster, the search engine compares the tags in that cluster's associated tag set with phrases in various lists, matching tags to phrases. Each such list corresponds to a different query intent; in each list, the phrases in that list are the phrases that are known to be associated with that list's query intent. By matching a particular cluster's tags to various lists, an intent corresponding to that particular cluster is determined; a different intent may be determined for each cluster. The intents determined for the clusters become the automatically identified intents of the user's query. For each such identified intent, the search engine may present, with query results, a type of content that corresponds especially to that intent (e.g., a map for a location intent). Additionally or alternatively, for each such identified intent, the search engine may organize or format the query results in a manner that suits the intent. In other embodiments, the search engine uses the tags for other purposes such as identifying terms that might help narrow a user's search or provide the user with other queries that might be of interest.

### List Matching

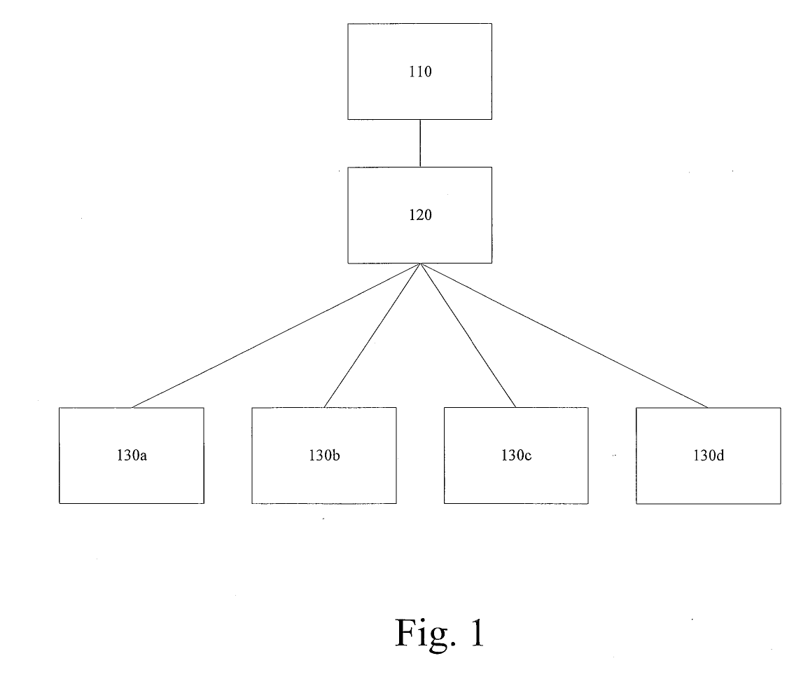

FIG. 1 shows a system embodying aspects of the present invention. The system includes a web client 110 configured to access a search engine host 120. The search engine host 120 is configured to execute search engine software that can provide a search page with a query entry mechanism to the web client 110, enabling a user to enter search terms. After receiving one or more search terms from a user of the web client 110, the search engine server 120 can query one or more databases 130a-d. The one or more databases 130a-d can store data entries associating a URL with information (e.g., keywords, category data, etc.) reflecting the content of a web page identified by the URL. The databases might additionally store other types of content associated with search terms, such as maps or pictures related to the search terms. Each data entry in the databases 130a-d might be assigned to one or more categories such as photos, maps, mobile web pages, local business web pages, shopping, movies, or any other type of category the designer of the search engine desires.

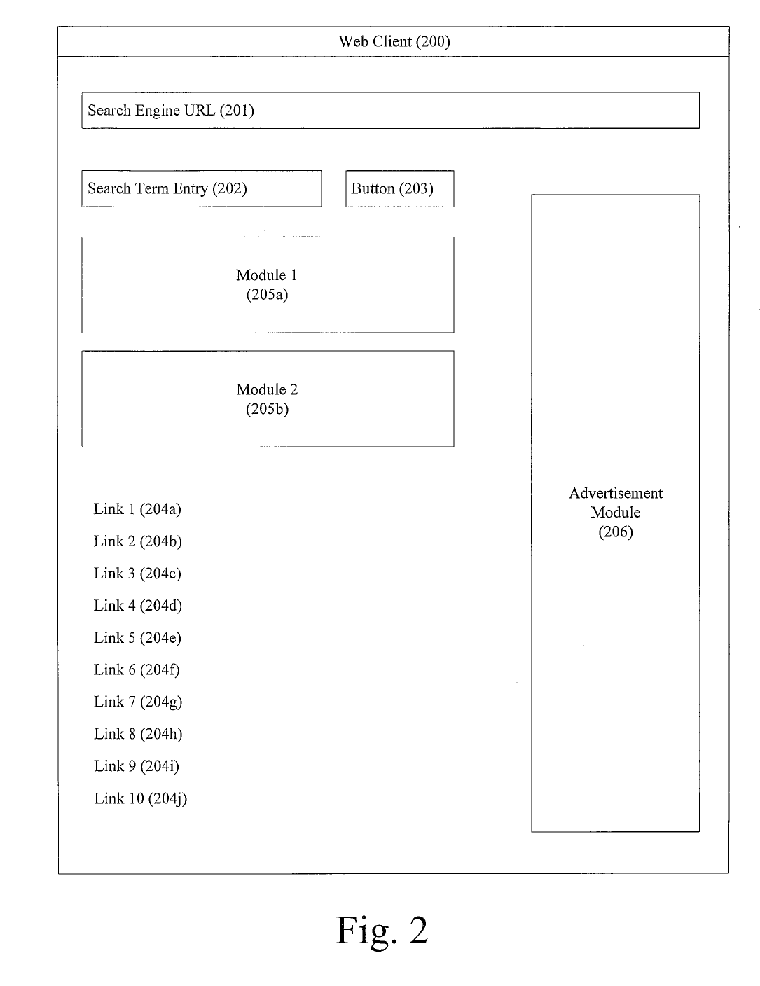

FIG. 2 is a generic representation of a search engine user interface that might be displayed in a web client 200 such as Internet Explorer® or Firefox®. Aspects of the present invention can also be applied to search engines and search engine interfaces configured for devices such as mobile phones and personal digital assistants. The web client 200 includes a URL entry module 201 for entering the URL of the search engine. In response to the user entering search terms into a search term entry box 202 and clicking a button 203 or pressing enter, the search engine will return a list of links 204a-j ranked according to a ranking algorithm used by the search engine. The search engine might also return, for example, one or more special modules 205a-b and an advertising module 206. Various numbers of special modules 205a-b and advertising modules 206 can be used, and their location can be varied depending on design preferences.

The search engine software operating on the search engine server 120 of FIG. 1 might additionally include query intent determination software that utilizes list matching to identify a specific intent for a query. The query intent determination software identifies the specific intent by comparing one or more of the entered search terms or combinations of search terms with a series of lists containing intent-signifying terms. If a search term or combination of search terms matches an intent-signifying term appearing on a list or combination of lists, then a specific intent for the query can be identified. For example, the search term “95125” might be on a list of valid zip codes, the search term “restaurant” might appear on a list of business types, and a search term corresponding to a movie title might appear on a list of movie titles.

In instances where the search term “95125” appears either by itself or with additional search terms not appearing in other lists, the query intent determination software might determine that the search has a map intent and place a picture link to a map in special module 205a or 205b. If the search term “95125” appears in the same query as the search term “restaurant,” then the query intent determination software might determine that the combination of a valid zip code and a business type indicates a local business intent and place links to websites of local businesses in special modules 205a and 205b, or the search engine might place a link to a map identifying local restaurants in either special module 205a or 205b and put a link to a restaurant reviewing web site in the other special module 205a or 205b. In instances where the search terms comprise a movie title, the query intent determination software might identify a movie intent, and one of the special modules 205a-b might be used to list movie times, movie reviews, or links to theatres.

The type of content or formatting that can be included in the special modules 205a-b is virtually limitless. For example, if search terms correspond to a celebrity name in a list of celebrity names, then one or more of the special modules 205a-b might be used to sell tickets to shows, compact discs, movies or other products related to that celebrity. The special modules 205a-b might also be used to display thumbnail picture links or “also try” suggestions recommending alternative, related searches the user might want to try. For example, if a user enters the search terms “Dark Knight,” then the search engine might present an “also try” suggestion of searching on “Heath Ledger.” The special modules 205a-b might also be used to display search assist recommendations that present the user with narrower searching options. For example, if a user searches on the term “jaguar,” the search engine might present to the user recommended, narrower search suggestions such as “Jacksonville Jaguar,” “Jaguar automobiles,” or “jaguar animal.”

In a search engine specially configured for the small screens of mobile devices, an identified intent might be used to determine an arrangement for groups of results as opposed to populate special modules 205a-b. For example, a mobile search engine might group links by category as opposed to listing the links strictly according to a ranking algorithm. In such a search engine, the determination of a movie intent might cause movie times to be listed at the top of the screen, whereas the determination of a local business intent might cause links to local businesses to be listed at the top of the screen. The number of lists that a search engine can maintain, the number of categories used to classify web pages, and the types of identifiable intents are virtually limitless, as are the ways in which the search engine might use those identified intents in determining content and formatting.

### Identifying Tags

As the content on the internet is always changing, in order to most accurately ascertain a user's intent when searching, many of the lists must also be constantly changing. One way to achieve this is to manually add and remove terms from the various lists, but in addition to being labor intensive and time-consuming, manually maintaining the lists can rely too heavily on the judgment of a few individuals which might not represent the searching habits of the hundreds of millions of people who use internet search engines. Maintaining the lists can also be difficult because each list needs to include all the various aliases or synonyms that different searchers might use when searching on a particular topic. For example, a user trying to search for the movie “The Dark Knight” might use the search terms “Dark Knight,” “Batman movie,” “movie with Heath Ledger,” or any one of a number of other different search terms. For the list matching system to work, all of these various combinations and permutations need to be included in the appropriate lists.

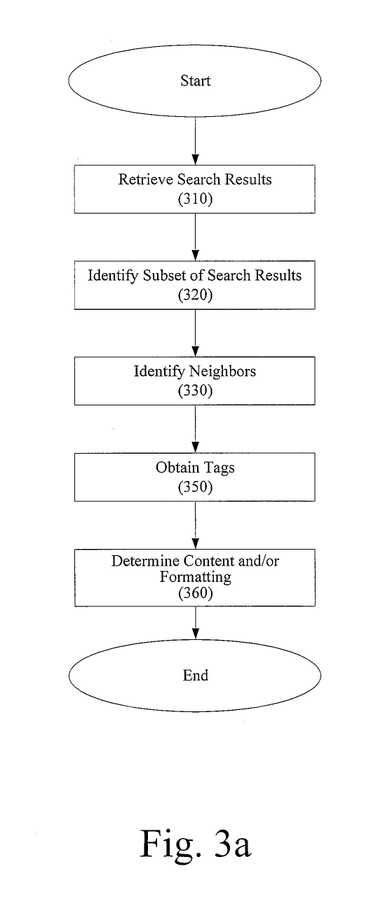

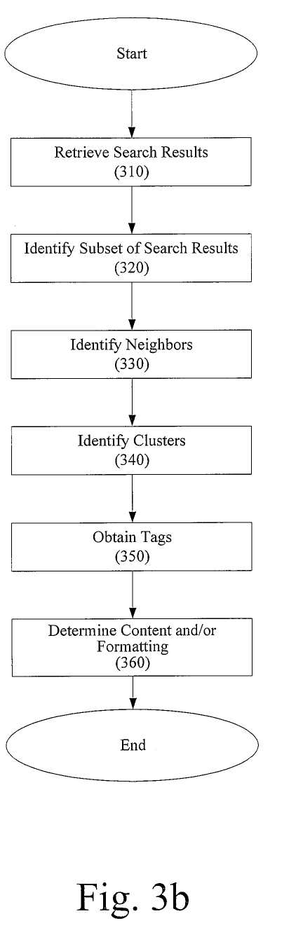

Aspects of the present invention improve the list matching system by utilizing social tagging to identify terms associated with the results of an internet search. FIG. 3a shows a flow chart illustrating an automated method for using tags to identify terms that can be matched to lists for determining a user's specific intent or used in other manners for determining the content or format of returned results. The method begins with a user entering a search query into a search engine interface, and the search engine retrieving a set of results ranked according to a ranking algorithm (block 310).

From the set of results, a certain subset of the results can be chosen to be analyzed further (block 320). The subset might, for example, be a specific number of the top results or might be chosen in a different manner, such as all results having a relevance score higher than a threshold value. For the subset of results, inlinks and/or outlinks for each result in the subset can be obtained from a webmap database storing information about the web or by other means such as from a web crawler. By obtaining the inlinks and/or outlinks, a group of neighbors (i.e., web pages that either link to or are linked from a result) can be obtained for each result in the subset of results (block 330). The linking relationships of the neighbors to one another (i.e., identifying neighbor sites that link to other neighbor sites) can also be identified.

Depending on implementation preferences, multiple levels of inlinks and/or outlinks might be obtained in order to identify the neighbors of neighbors as well as the linking relationships between the all different neighbors of neighbors. For example, a first level of neighbors might be retrieved by identifying all the web pages that either link to or are linked from the subset of results, and a second level of neighbors might be retrieved by identifying all the web pages that either link to or are linked from the web pages in the first level of web pages. Additional levels might also be obtained if desired.

From the group of neighbors and the subset of results, a set of tags can be obtained (block 350). The tags associated with each web page might be assigned to the web page by users of a social bookmarking website such as DELICIOUS.COM® or through any other means known in the art. Users of social bookmarking websites such as DELICIOUS.COM® can assign tags to websites that the users wish to save or bookmark. For example, users might tag all sports-related bookmarks with the word “sports” and all movie-related bookmarks with the word “movie.” Each website might have multiple tags. For example, baseball-related websites might be tagged with the word “baseball” in addition to the word “sports,” and all movie-related websites might be tagged with the names of actors and actresses or movie characters in addition to the word “movie.” Social bookmarking allows users to determine the words that they prefer to associate with any given URL, even if that word association is counter-intuitive or illogical to a majority of other users. For example, a user might assign the tag “honeymoon” to a web page for a particular restaurant, even though that association that might only be meaningful to that one particular user.

From the set of tags, a subset of the tags, such as the most frequently occurring tags, might be identified. For example, some users assigning tags to URLs associated with the movie “The Dark Knight” might assign tags such as “weekend activity” or “popcorn,” but the most popular tags will probably be terms like “movie,” “Batman,” and “Heath Ledger.” Once identified, the subset of tags can be used by intent determination software to determine content or formatting in the way search terms are used to determine content and formatting as described above (block 360). For example, if a user searches on the term “Dark Knight” and one of the identified tags is “movie,” then the term “movie” can be matched to a list of terms that identify a movie intent, and the search engine can present the user with movie times in a special module.

An aspect of the described system is that it allows the term “Dark Knight” to be associated with a movie intent without having to enter the term “Dark Knight” into a list of movies, which has the benefit of being administratively easier for a search engine provider. Instead of having a search engine administrator add the specific term “Dark Knight” to a movie list, an association between “Dark Knight” and the more generic term “movie” can be determined based on the tagging behavior of internet users. Therefore, as long as the more generic term “movie” is in an appropriate list, the term “Dark Knight” can be associated with that list without “Dark Knight” specifically being added to that list.

Further aspects of the described system include using filters or weightings when identifying the subset of tags. For example, tags added within the last seven days might be given a first weight, tags added between seven and three-hundred days ago might be given a second weight, and tags added more than three-hundred days ago might be given a third weight, such that the newer tags are assigned more importance than the older tags. The system might alternatively only analyze tags that have been added within a certain time period. By considering the age of a tag when identifying the subset of tags, changes in the searching intents of internet users can be rapidly detected. For example, the term “jaguar” might be most commonly associated with luxury automobiles, but it also refers to an animal as well as a professional football team. If, however, the professional football team from Jacksonville makes the Super Bowl, then for the period of time surrounding the Super Bowl, the term “jaguar” might be most commonly associated with football rather than luxury automobiles. In the present system, the search term “jaguar” would not have to be added or removed from any lists in response to this change because as the tag most frequently associated with the results for the search term “jaguar” changed, for example, from “automobile” to “football,” the intent determination software could detect that change and determine the content or formatting of search results accordingly.

The types of content or formatting that can be determined from the tags are virtually limitless. For example, as discussed above in reference to search terms, the content or location of special modules or advertising modules might be based on identified tags, or tags might be used to determine thumbnail picture links or “also try” suggestions that might be of interest to a user, or in a search engine specially configured for the small screens of mobile devices, tags might be used to determine an order in which to displays groups of results.

### Identifying Clusters of Neighbors

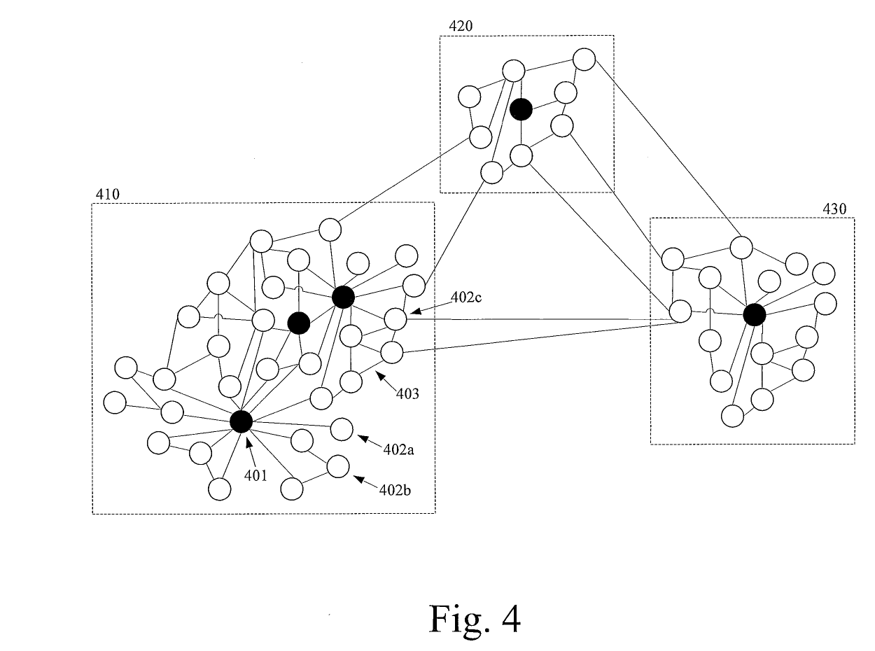

In one embodiment, the present system can identify clusters of neighbors and use those clusters in determining the content or formatting of search results. FIG. 4 is a graphical illustration of a webmap obtained from identifying two levels of neighbors. URLs are represented as nodes (e.g. 401 and 402a-c) while inlinks and outlinks are represented as lines (e.g. 403). The dark nodes (e.g. 401) represent the subset of results obtained from a search engine query, and the white nodes (e.g. 402a-c) represent neighbors that either link to or are linked from a result in the subset of results. White node 402a, for example, represents a URL that is a neighbor of a result from the subset of results, and white node 402b represents a URL that is a neighbor of a neighbor. White node 402c represents a URL that is both a neighbor of a result of the subset of results, and a neighbor of a neighbor.

FIG. 3b shows a flow chart illustrating a method for using tags and clusters to identify terms that can be matched to lists for determining a user's specific intent or used in other manners for determining the content or format of returned results. As described above in reference to FIG. 3a, a set of search results can be retrieved (block 310), and a subset of the search results can be identified (block 320). For the subset of search results, neighbors and their linking relationships can be identified (block 330).

By analyzing boundary conditions for each node 401 and 402a-c, clusters can be identified (block 340). Clusters might also be identified by using one or more of the cluster algorithms known in the art such as the Markov Clustering algorithm, k-nearest neighbor algorithm, or Girvan-Newman algorithm. Typically, clusters will represent groups of web pages that have similar content. For example, if the search term “Batman” is entered, the nodes of cluster 410 might represent URLs related to the movie “The Dark Knight,” the nodes of cluster 420 might represent URLs related to the 1989 Batman movie, and the nodes of cluster 430 might represent URLs related to Batman comic books. Although, some nodes within one cluster might link to nodes in another cluster, the majority of linking is between URLs of the same clusters.

Once the clusters are identified, the tags of each cluster might be obtained as described above (block 350) and used to determine content or formatting (block 360). The system might, for example, generate blended results based on intent by using the tags of the largest cluster (e.g. 410) to determine content for a first special module and the tags of the second largest cluster to determine the content for a second special module. Alternatively, the system might use the tags of smaller clusters to provide recommendations for alternative searches to users. For example, if the most popular tag in the largest cluster 410 is “movie,” and the most popular tag in the second largest cluster 430 is “comic,” then the system might present movie-related content in two special modules and present the user with an also-try suggestion saying, for example, “Click here for ‘Batman Comic’ results.”

The relative size of the clusters might be determined based on the number of nodes within the cluster and/or the number of inlinks and/or outlinks within the cluster, but it might also be determined with consideration to other factors such as the size and popularity of nodes within the cluster. For example, nodes representing frequently visited URLs or URLs with large numbers of pages in their domain might be given more weight than nodes representing smaller or infrequently visited URLs.

### Hardware Overview

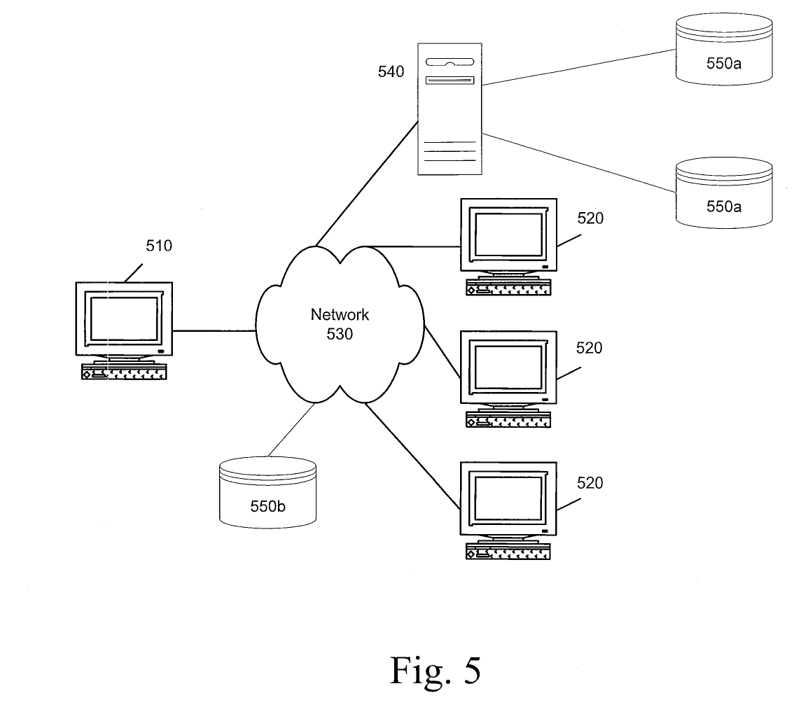

FIG. 5 illustrates the components of a possible network architecture for implementing a search system embodying aspects of the present invention. The system 500 can include one or more master terminals 510, one or more user terminals 520, and one or more servers 540 connected through a network 530. One or more of the terminals 510, 520 may be personal computers, computer workstations, PDAs, mobile phones or any other type of microprocessor-based device that can execute web-client software. The one or more servers 540 can be used for storing search engine software, including query-intent determination software. The one or more servers 540 can further access one or more databases 550a-b. The databases may either be accessed directly or over the network 530.

The network 530 may be a local area network (LAN), wide area network (WAN), remote access network, an intranet, or the Internet, for example. Network links for the network 530 may include telephone lines, DSL, cable networks, T1 or T3 lines, wireless network connections, or any other arrangement that implements the transmission and reception of network signals. However, while FIG. 5 shows the terminals 510, 520, servers 540, and databases 550b connected through a network 530, the terminals 510, 520, servers 540, and databases 550b may alternatively be connected through other means, including directly hardwired as in the case of database 550b or wirelessly connected. In addition, the terminals 510, 520, servers 540, and databases 550a-b may be connected to other network devices not shown, such as wired or wireless routers.

It will be readily apparent to one skilled in the art that the components described in reference to FIG. 1 might be contained on one terminal 510, 520, server 540, or database 550a-b or may distributed over multiple terminals 510, 520, servers 540, and databases 550a-b spread out across the system.

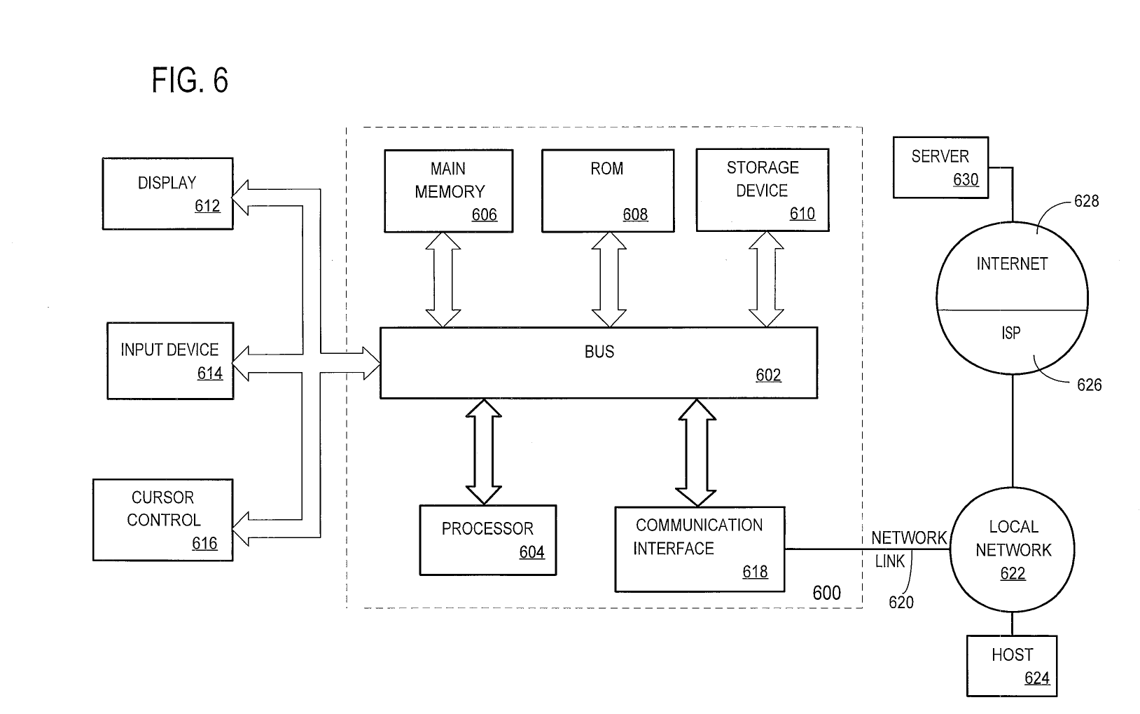

FIG. 6 is a block diagram that illustrates a computer system 600 upon which an embodiment of the invention may be implemented. Computer system 600 includes a bus 602 or other communication mechanism for communicating information, and a processor 604 coupled with bus 602 for processing information. Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

The invention is related to the use of computer systems such as computer system 600 for accessing a search engine or hosting search engine software. According to one embodiment of the invention, a search query can be sent by computer system 600 in response to processor 604 executing one or more sequences of one or more instructions contained in main memory 606. Such instructions may be read into main memory 606 from another computer-readable medium, such as storage device 610. Execution of the sequences of instructions contained in main memory 606 causes processor 604 to perform the process steps described herein. One or more processors in a multi-processing arrangement may also be employed to execute the sequences of instructions contained in main memory 606. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 604 for execution. Such a medium may take many forms, including but not limited to, non-volatile media, volatile media, and transmission media. Non-volatile media includes, for example, optical or magnetic disks, such as storage device 610. Volatile media includes dynamic memory, such as main memory 606. Transmission media includes coaxial cables, copper wire and fiber optics, including the wires that comprise bus 602. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 604 for execution. For example, the instructions may initially be carried on a magnetic disk of a remote computer. The remote computer can load the instructions into its dynamic memory and send the instructions over a telephone line using a modem. A modem local to computer system 600 can receive the data on the telephone line and use an infrared transmitter to convert the data to an infrared signal. An infrared detector coupled to bus 602 can receive the data carried in the infrared signal and place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the worldwide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are exemplary forms of carrier waves transporting the information.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618. In accordance with the invention, one such application provides for a search engine as described herein.

The received code may be executed by processor 604 as it is received, and/or stored in storage device 610, or other non-volatile storage for later execution. In this manner, computer system 600 may obtain application code in the form of a carrier wave.

### Extensions and Alternatives

In this description certain process steps are set forth in a particular order, and alphabetic and alphanumeric labels may be used to identify certain steps. Unless specifically stated in the description, embodiments of the invention are not necessarily limited to any particular order of carrying out such steps. In particular, the labels are used merely for convenient identification of steps, and are not intended to specify or require a particular order of carrying out such steps.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A machine-implemented method comprising:
identifying a plurality of search results in response to a user entering a search query;
identifying a group of neighbor websites for a subset of the plurality of search results;
identifying a set of tags for the neighbor websites; and,
determining formatting or content for a web page presenting the plurality of search results to the user based on one or more tags from the set of tags.

2. The machine-implemented method of claim 1, wherein the subset of the plurality of search results is chosen based on a ranking algorithm used to rank the plurality of search results.

3. The machine-implemented method of claim 1, wherein identifying the group of neighbor websites comprises identifying websites that link to a result from the subset of the plurality of search results.

4. The machine-implemented method of claim 1, wherein identifying the group of neighbor websites comprises identifying websites linked from a result from the subset of the plurality of search results.

5. The machine-implemented method of claim 1 further comprising:
identifying linking relationships between the group of neighbor websites; and
identifying clusters within the group of neighbor websites;
determining formatting or content for the web page presenting the plurality of search results to the user based on one or more tags from a first cluster.

6. The machine-implemented method of claim 5, further comprising:
determining a size for each of the clusters;
determining formatting or content for the web page presenting the plurality of search results to the user based on one or more tags from a second cluster, the second cluster not being the largest cluster.

7. The machine-implemented method of claim 6, wherein determining the size of the clusters comprises determining a number of nodes and a number of inlinks or outlinks in the clusters.

8. The machine-implemented method of claim 7, wherein determining the size of the clusters further comprises determining a number of pages in a node's domain.

9. The machine-implemented method of claim 7, wherein determining the size of the clusters further comprises determining a popularity for a node.

10. The machine-implemented method of claim 1, wherein determining formatting or content for the web page presenting the plurality of search results to the user includes identifying a presence of the one or more tags on a list.

11. The machine-implemented method of claim 1, wherein determining formatting or content for the web page presenting the plurality of search results to the user includes determining content for a special module.

12. The machine-implemented method of claim 1, wherein determining formatting or content for the web page presenting the plurality of search results to the user includes determining an “also-try” suggestion.

13. The machine-implemented method of claim 1, wherein determining formatting or content for the web page presenting the plurality of search results to the user includes determining a search assistance suggestion.

14. The machine-implemented method of claim 1, wherein determining formatting or content for the web page presenting the plurality of search results to the user includes determining which results from the plurality of results to locate at a particular position on a screen.

15. A computer system, the system comprising:
one or more processors; and
a memory coupled to the processor, the memory storing one or more sequences of instructions, wherein execution of the one or more sequences of instructions by the one or more processors causes the processors to perform the steps of:
identifying a plurality of search results in response to a user entering a search query;
identifying a group of neighbor websites for a subset of the plurality of search results;
identifying a set of tags for the neighbor websites; and,
determining formatting or content for a web page presenting the plurality of search results to the user based on one or more tags from the set of tags.

16. The system of claim 15, wherein the subset of the plurality of search results is chosen based on a ranking algorithm used to rank the plurality of search results.

17. The system of claim 15, wherein identifying the group of neighbor websites comprises identifying websites that link to a result from the subset of the plurality of search results.

18. The system of claim 15, wherein identifying the group of neighbor websites comprises identifying websites linked from a result from the subset of the plurality of search results.

19. The system of claim 1, the memory storing one or more sequences of instructions, wherein execution of the one or more sequences of instructions by the one or more processors causes the processors to perform the additional steps of:
identifying linking relationships between the group of neighbor websites; and
identifying clusters within the group of neighbor websites;
determining formatting or content for the web page presenting the plurality of search results to the user based on one or more tags from a first cluster.

20. The system of claim 19, the memory storing one or more sequences of instructions, wherein execution of the one or more sequences of instructions by the one or more processors causes the processors to perform the additional steps of:
determining a size for each of the clusters;
determining formatting or content for the web page presenting the plurality of search results to the user based on one or more tags from a second cluster, the second cluster not being the largest cluster.

21. The system of claim 20, wherein determining the size of the clusters comprises determining a number of nodes and a number of inlinks or outlinks in the clusters.

22. The system of claim 21, wherein determining the size of the clusters further comprises determining a number of pages in a node's domain.

23. The system of claim 21, wherein determining the size of the clusters further comprises determining a popularity for a node.

24. The system of claim 15, wherein determining formatting or content for the web page presenting the plurality of search results to the user includes identifying a presence of the one or more tags on a list.

25. The system of claim 15, wherein determining formatting or content for the web page presenting the plurality of search results to the user includes determining content for a special module.

26. The system of claim 15, wherein determining formatting or content for the web page presenting the plurality of search results to the user includes determining an “also-try” suggestion.

27. The system of claim 15, wherein determining formatting or content for the web page presenting the plurality of search results to the user includes determining a search assistance suggestion.

28. The system of claim 15, wherein determining formatting or content for the web page presenting the plurality of search results to the user includes determining which results from the plurality of results to locate at a particular position on a screen.
